(19) United States
(12) Patent Application Publication
(10) Pub. No.: US 2012/0156427 A1
(43) Pub. Date: Jun. 21, 2012

(54) Product and Method of Producing a Shape-Retaining Nonwoven Material

(75) Inventors: Ehud Giloh, Radcliffe (GB); Tamar Giloh, Radcliffe (GB)

(73) Assignee: TAMICARE LTD., Radcliffe (GB)

(21) Appl. No.: 13/328,024

(22) Filed: Dec. 16, 2011

Related U.S. Application Data
(60) Provisional application No. 61/424,475, filed on Dec. 17, 2010.

(51) Int. Cl. B32B 3/10; B23P 11/00; D04H 13/00

(52) U.S. Cl. 428/136; 442/328; 428/138; 28/100

(57) ABSTRACT

A hybrid, shape-retaining nonwoven structure of at least two layers is disclosed, A first functional layer includes an expandable nonwoven sheet having an expansion character allowing for elongation in at least one direction and a second functional layer includes a shape-retaining material. The first functional layer and second functional layer are associated with each other.

### CROSS-REFERENCE TO RELATED APPLICATIONS

The present application is a non-provisional of U.S. application Ser. no. 61/424,475 filed on Dec. 17, 2010, which is herein incorporated by reference in its entirety.

### BACKGROUND

Thermoplastic nonwoven fabrics are widely used in many industries, including the hygiene field, for production of personal care products like baby diapers and pull-ups, feminine hygiene pads, and incontinence products. One of the disadvantages of thermoplastic nonwoven sheets is their relatively poor stretchability, and more particularly their poor resiliency. This is a disadvantage in many applications including diapers, protective undergarments, and related components.

High stretchabilty features improve products' body hugging ability, thus improving the look, feel, and performance of products. Forming a significantly stretchable and significantly shape-retaining (recovery feature) nonwoven film, that includes stretchable thermoplastic fibers, is desirable, but difficult to achieve.

The material and technologies developed and owned by TamiCare Ltd. (for example, U.S. Pat. Nos. 6,987,210, 7,354,424, and 7,767,133 and U.S. Pat. Pub. No. 2008/0292788) provide a soft and fabric-like shape-retaining nonwoven structure. However, an alternative nonwoven sheet made of thermoplastic materials, for the converting industry, would be highly desirable where different qualities and lower costs are needed.

### SUMMARY

A hybrid, shape-retaining nonwoven structure of at least two layers including at least a first functional layer and a second functional layer is provided. The first functional layer comprises an expandable nonwoven sheet having an expansion character allowing for elongation in at least one direction. The second functional layer comprises a shape-retaining material. The first functional layer and second functional layer are associated with each other.

In one aspect of the hybrid, shape-retaining nonwoven structure, the expandable nonwoven sheet comprises synthetic and thermoplastic fibers in a specific orientation or pattern, such that a stretching force applied to the first functional layer causes elongation of the first functional layer in at least one direction.

In another aspect of the hybrid, shape-retaining nonwoven structure, the first functional layer includes cuts, openings, or slits, such that a stretching force applied to the first functional layer causes elongation of the first functional layer in at least one direction.

In another aspect of the hybrid, shape-retaining nonwoven structure, the shape-retaining material comprises an elastomer or polymer, the elastomer or polymer being synthetic or natural, or a combination of several polymers.

In another aspect of the hybrid, shape-retaining nonwoven structure, the first functional layer can be expanded by at least 10%, or at least 25%, or at least 50%, or at least 100%, or at least 150%, or at least 200%, or at least more than 200%.

In another aspect of the hybrid, shape-retaining nonwoven structure, a third functional layer is included and which comprises an expandable nonwoven sheet having an expansion character allowing for elongation in at least one direction, wherein the second functional layer is located between the first functional layer and the third functional layer.

In yet another aspect of the hybrid, shape-retaining nonwoven structure, the expandable nonwoven sheet further comprises textile fibers.

A method to produce a hybrid shape-retaining nonwoven structure is also disclosed. The method includes providing a first functional layer comprising an expandable nonwoven sheet having an expansion character allowing for elongation in at least one direction and associating a second functional layer comprising a shape-retaining material with at least a portion of the first functional layer.

In one aspect of the method, the associating includes embedding a resilient elastomer onto the first functional layer.

In another aspect of the method, the expandable nonwoven sheet comprises synthetic and thermoplastic fibers in a specific orientation or pattern, such that a stretching force applied to the first functional layer causes elongation of the first functional layer in at least one direction.

In another aspect of the method, the first functional layer includes cuts, openings, or slots, such that a stretching force applied to the first functional layer causes elongation of the first functional layer in at least one direction.

In another aspect of the method, the shape-retaining material comprises an elastomer or polymer, the elastomer or polymer being synthetic or natural, or a combination of several polymers.

In another aspect of the method, the first functional layer can be expanded by at least 10%, or at least 25%, or at least 50%, or at least 100%, or at least 150%, or at least 200%, or at least more than 200%.

In another aspect of the method, a third functional layer is included and which comprises an expandable nonwoven sheet having an expansion character allowing for elongation in at least one direction, wherein the second functional layer is located between the first functional layer and the third functional layer.

In yet another aspect of the method, the expandable nonwoven sheet further comprises textile fibers.

These and other embodiments and aspects are described below.

### BRIEF DESCRIPTION OF THE FIGURES

FIG. 1 shows a nonwoven structure of at least two layers the present application in a rest position.

FIG. 2 shows the nonwoven structure shown in FIG. 1 in a stretched position.

FIG. 3 is a schematic graphical presentation of a nonwoven structure of at least two layers wherein the fibers are oriented in a sinus wave geometrical pattern in the rest position.

FIG. 4 is a schematic graphical presentation of the nonwoven structure shown in FIG. 3 in a stretched and expanded position in all directions.

FIG. 5 shows another embodiment of a nonwoven structure of at least two layers in the rest position.

FIG. 6 shows the nonwoven structure shown in FIG. 5 in the stretched position.

FIG. 7 shows a schematic close-up of two fibers laid substantially in a parallel direction, having two connection points along the laid direction.

FIG. 8 shows a schematic graphical presentation of a nonwoven structure with cuts in a relaxation position.

FIG. 9 shows a schematic graphical presentation of the nonwoven structure of FIG. 8 in a stretched position.

### DETAILED DESCRIPTION

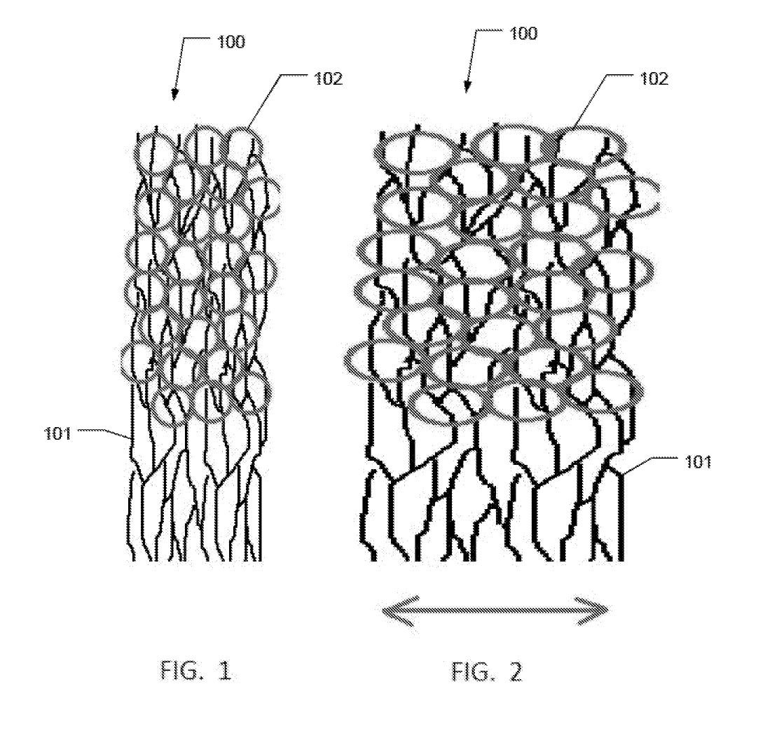

Referring to FIG. 1, the hybrid, shape-retaining nonwoven structure or sheet 100 of the present application includes at least two functional layers 101 and 102 combined in various ways, so as to provide versatile and resilient hybrid nonwoven sheets or structures. The sheet 100 can be stretched at least in one direction, usually a cross direction (CD) or machine direction (MD) of the converting machine, or in both MD and CD directions, or in any desired direction.

The term “machine direction” as applied to a nonwoven sheet, refers to the direction of travel of a machine conveyor. The term “cross direction” for a nonwoven sheet refers to the direction perpendicular to the machine direction.

The first functional layer 101 of the hybrid nonwoven structure may be an expandable nonwoven sheet made by using nonwoven technologies known in the art, such as spun bond, spun melt, spun lace, spun blown, wet laid, dry laid, or any other technique or combination of technologies thereof, or by any suitable nonwoven technology.

The expandable nonwoven sheet 101 may comprise synthetic and thermoplastic fibers. The expandable nonwoven sheet is formed in such a way that enables the sheet to be extendible or expandable, or elongated. The term “expandable” or “extendible” is used herein to mean a material which upon application of a stretching force, can be extended in a particular direction, to a stretched dimension (e.g., width) which is at least 10%, or more preferably 25%, or more preferably 50%, or more preferably 100%, or more preferably 150%, or more preferably 200%, or more preferably more than 200% greater than an original, unstretched dimension. Any suitable synthetic or thermoplastic fiber may be used to prepare the non-woven layer or sheet. The second functional layer 102 of the nonwoven structure may be formed of a shape-retaining material allowing the recovery of the first layer, which may be made substantially of synthetic or natural elastomers or polymers such as latex, for example. The second functional layer may be formed out of individual droplets, interconnected droplets, a mixture of individual and interconnected droplets, film, perforated film, fibers, threads, flakes, any combination thereof or any other form that will result with the desired features as defined in the present application. The second layer may also include recycled particles of natural or synthetic elastomer in form of fibers, wires, flakes, bits, or combination thereof.

The second functional layer 102 may be embedded into or applied onto the first functional layer during the manufacturing process by spraying, injection, extrusion, lamination, coating, brushing, suing, or by any other suitable method known in the art.

As a result of combining, merging, fusing or embedding the second functional layer with the first functional layer, a hybrid shape-retaining nonwoven sheet with high stretchablity and recovery features is created.

The two functional layers 101, 102 can be combined or associated in various ways such as one on top of the other, one inside the other, side by side without overlapping, side by side with overlapping, randomly mixed, in a matrix, according to a pattern, or in any combination thereof. The hybrid nonwoven shape-retaining sheet 100 can be connected to or attached to or embedded with other materials such as absorptive articles, other sheets, or any other desired article.

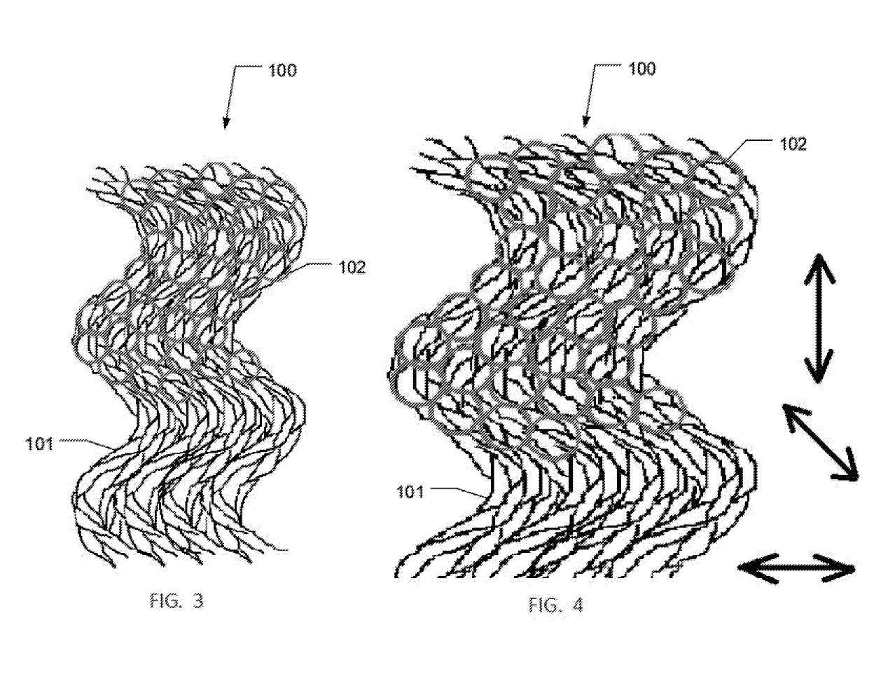

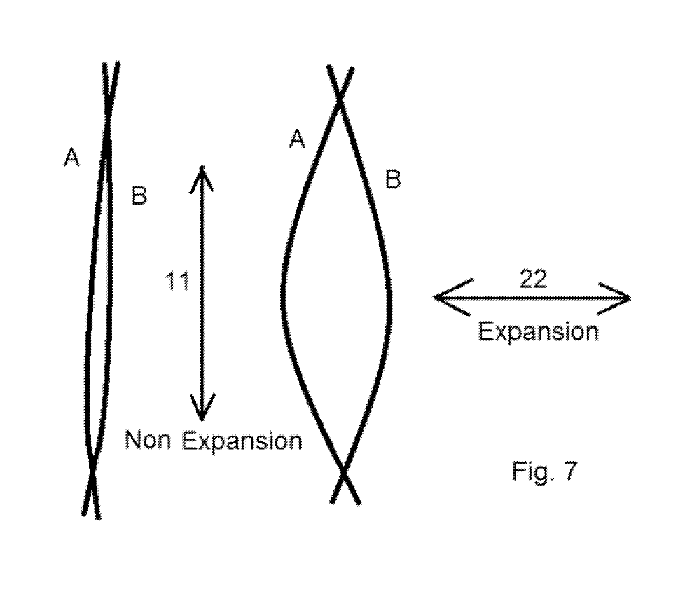

In one embodiment, the expansion or elongation of the shape-retaining nonwoven structure 100 is achieved by applying the thermoplastic fibers on a moving surface such as a rotating drum, calendar, mold, or a conveyor in a specific orientation or pattern, allowing more flexibility. One example of a possible thermoplastic fibers pattern is a basic parallel layout, as shown in FIG. 1, FIG. 2, and FIG. 7. In another embodiment, a possible thermoplastic fibers layout is a spiral pattern.

Yet another embodiment of a possible thermoplastic fibers layout is a sine wave pattern, as shown in FIG. 3 and FIG. 4. In FIGS. 3 and 4, the second functional layer 102 may include droplets 102, which may be an elastomeric polymer. The arrows show the expansion directions of the nonwoven layout. A combination of some of the possible thermoplastic fibers layouts is also possible.

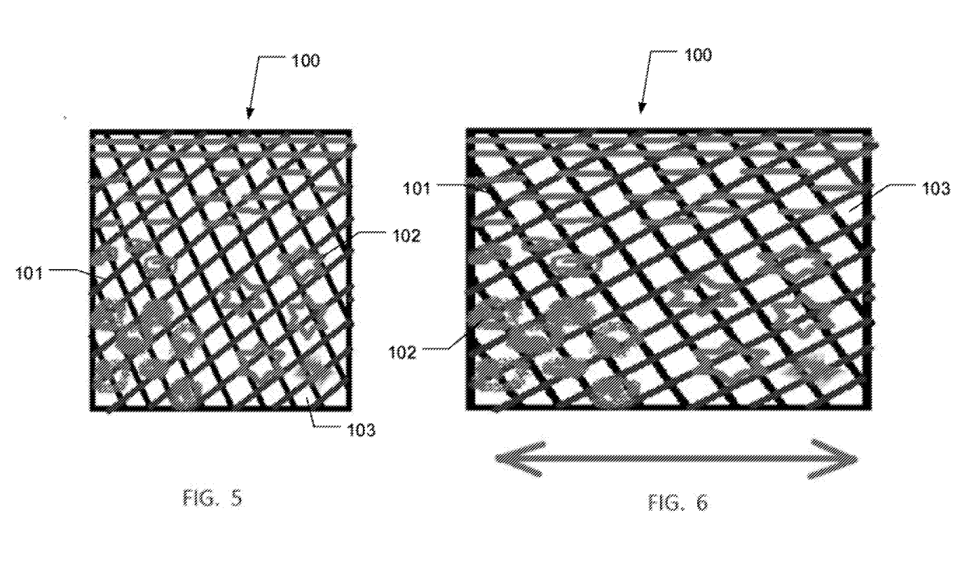

FIGS. 5 and 6 show another embodiment of the nonwoven sheet 100 having two functional layers 101 and 102. The first functional layer 101 may comprise cuts, slits, or openings 103 that enable expansion as a result of a stretching force applied on the sheet.

FIG. 7 shows two fibers, A and B, laid substantially in a parallel direction, having two connection points along the laid direction. FIG. 7 demonstrates a non-expansion nature along the laid direction 11 and an expansion quality at the perpendicular direction 22.

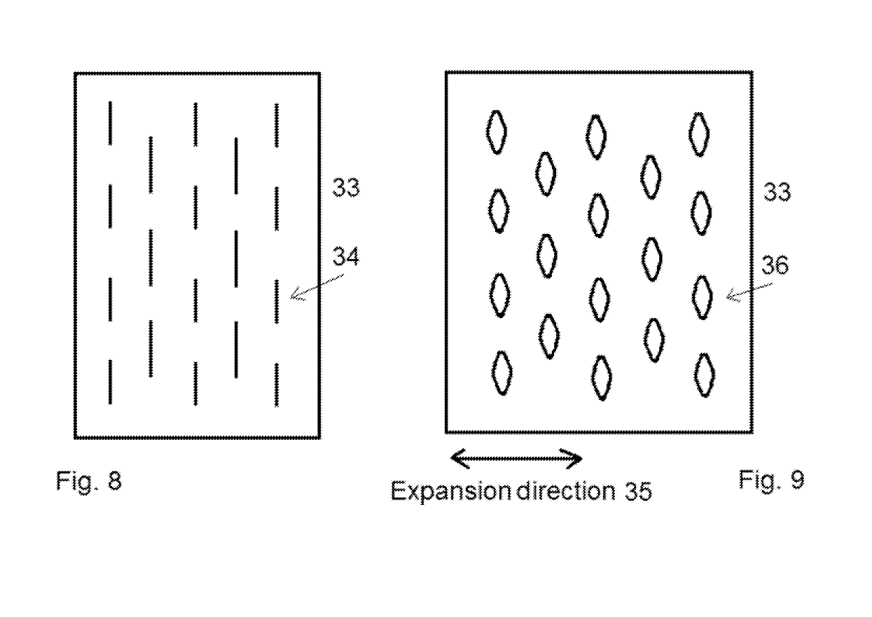

In yet another embodiment, expansion is achieved by creating a geometrical structure on a finished nonwoven sheet. For example, the geometrical structure may be created in the sheet by providing cuts, slits, or openings in the sheets. A stretching force applied to the sheet in a perpendicular direction to the cuts direction allows for expansion or elongation of the sheet, as shown in FIG. 8 and FIG. 9. FIG. 8 shows a nonwoven sheet 33 with cuts 34 in a relaxation position, and FIG. 9 shows the nonwoven sheet 33 with stretching forces applied to the sheet in the expansion direction 35 deforming the cuts 36 to allow expansion.

The two functional layers may be further combined with a third layer, such as an additional expandable nonwoven sheet and/or an additional elastomer layer. The two remote layers are expandable nonwoven layers, and the middle layer is a shape-retaining resilient functional layer. Such additional layers may be made of the same or different material or geometrical patterns.

The hybrid shape-retaining nonwoven sheet 100 of the present application may further comprise one external surface layer or two external surface layers made of textile fibers, such as loose cotton fibers, loose viscose fibers, paper fibers, bits or flakes, fur, cellulose based fibers, or any other fibers that are pleasant and comfortable when in contact with the skin. The textile fibers can be applied on the surface of the hybrid nonwoven shape retaining sheet by any suitable method such as flocking, pressing or any other suitable method known in the art.

The use of different combinations of different materials allows versatility of properties such as elasticity, resiliency, elongation, recovery, biodegradability, look, feel, and cost efficiency.

The hybrid, shape-retaining nonwoven sheet 100 may be prepared using existing machinery to create nonwoven fabrics with any suitable modifications including a fibers guidance system that defines the layout pattern of the fibers while laid on the moving surface (conveyor belt, dram etc.) of the machine, either by vacuum, comb-like manipulator, or any other suitable means, which forces the fiber to set on the moving surface in a controlled manner, so that the desired geometrical patterns are created. This is in contrast to current technologies where the fibers are randomly laid on the moving surface. In another example, online or offline apparatuses are appropriate for creating the cuts in the at least one nonwoven fabric sheet and applying the at least one elastomer layer. A resilient elastomer application system such as nozzles, brushes, laminators, needles, or other suitable means may be added.

While certain features and embodiments of the present application have been described in detail herein, it is to be understood that the application encompasses all modifications and enhancements.

1. A hybrid, shape-retaining nonwoven structure of at least two layers comprising:
at least a first functional layer and a second functional layer;
wherein the first functional layer comprises an expandable nonwoven sheet having an expansion character allowing for elongation in at least one direction;
wherein the second functional layer comprises a shape-retaining material; and
wherein the first functional layer and second functional layer are associated with each other.

2. The hybrid, shape-retaining nonwoven structure according to claim 1, wherein the expandable nonwoven sheet comprises synthetic and thermoplastic fibers in a specific orientation or pattern, such that a stretching force applied to the first functional layer causes elongation of the first functional layer in at least one direction.

3. The hybrid, shape-retaining nonwoven structure according to claim 1, wherein the first functional layer includes cuts, openings, or slits, such that a stretching force applied to the first functional layer causes elongation of the first functional layer in at least one direction.

4. The hybrid, shape-retaining nonwoven structure according to claim 1, wherein the shape-retaining material comprises an elastomer or polymer, the elastomer or polymer being synthetic or natural, or a combination of several polymers.

5. The hybrid, shape-retaining nonwoven structure according to claim 1, wherein the first functional layer can be expanded by at least 10%, or at least 25%, or at least 50%, or at least 100%, or at least 150%, or at least 200%, or at least more than 200%.

6. The hybrid, shape-retaining nonwoven structure according to claim 1, further comprising a third functional layer comprising an expandable nonwoven sheet having an expansion character allowing for elongation in at least one direction, wherein the second functional layer is located between the first functional layer and the third functional layer.

7. The hybrid, shape-retaining nonwoven structure according to claim 1, wherein the expandable nonwoven sheet further comprises textile fibers.

8. A method for producing a hybrid, shape-retaining nonwoven structure of at least two layers, the method comprising:
providing a first functional layer comprising an expandable nonwoven sheet having an expansion character allowing for elongation in at least one direction; and
associating a second functional layer comprising a shape-retaining material with at least a portion of the first functional layer.

9. The method according to claim 8, wherein the associating includes embedding a resilient elastomer onto the first functional layer.

10. The method according to claim 8, wherein the expandable nonwoven sheet comprises synthetic and thermoplastic fibers in a specific orientation or pattern, such that a stretching force applied to the first functional layer causes elongation of the first functional layer in at least one direction.

11. The method according to claim 8, wherein the first functional layer includes cuts, openings, or slots, such that a stretching force applied to the first functional layer causes elongation of the first functional layer in at least one direction.

12. The method according to claim 8, wherein the shape-retaining material comprises an elastomer or polymer, the elastomer or polymer being synthetic or natural, or a combination of several polymers.

13. The method according to claim 8, wherein the first functional layer can be expanded by at least 10%, or at least 25%, or at least 50%, or at least 100%, or at least 150%, or at least 200%, or at least more than 200%.

14. The method according to claim 8, further comprising a third functional layer comprising an expandable nonwoven sheet having an expansion character allowing for elongation in at least one direction, wherein the second functional layer is located between the first functional layer and the third functional layer.

15. The method according to claim 8, wherein the expandable nonwoven sheet further comprises textile fibers.
